(19) United States
(12) Patent Application Publication
(10) Pub. No.: US 2005/0100505 A1
(43) Pub. Date: May 12, 2005

(54) Ozone dryer/washer

(76) Inventor: Jonathan Bruce, Everett, WA (US)

Correspondence Address: Jonathan Bruce, 2201 Oklahoma Ave., Everett, WA, 98201, US

(21) Appl. No.: 10/626,853

(22) Filed: May 21, 2003

(51) Int. Cl. C01B 13/10; C01B 15/00

(52) U.S. Cl. 423/581

(57) ABSTRACT

This invention will make life easier in the energy business. Plenty of clean heat or coolant. Heat it up past coolant level (since compression cools it) and it should be hot air at the end.

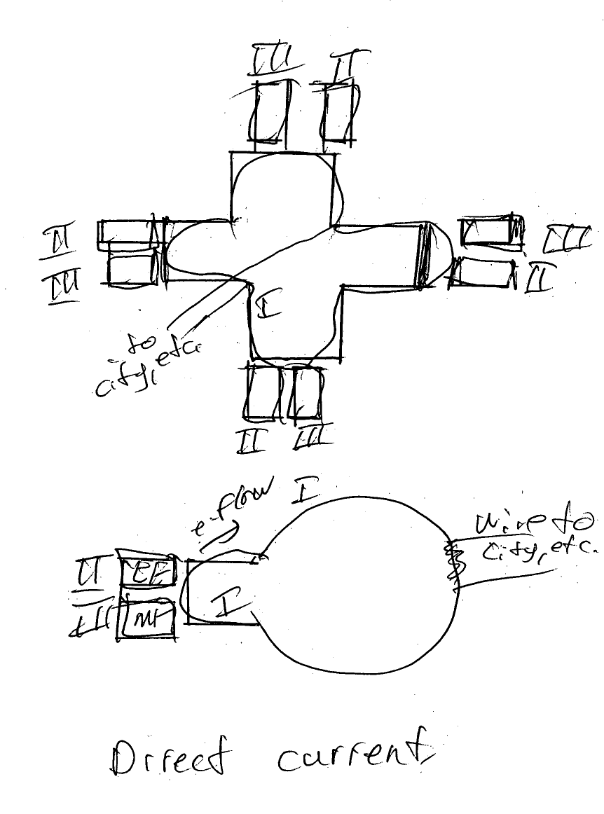

### BACKGROUND

(1) Engineering and physics

(2) Japan 405312405 A (Heat pump type hot water feeder)/JP 355095055 (Control circuit of air-conditioning system)

### SUMMARY

Turn electricity into heat or coolant (with compressor). Compress air and pull it in, heat it or cool it, then release the air out of the other vent.

### DRAWING FIGURES

The drawing is of the invention aforementioned. It is a general improvement over old heat and cooling sources. The air goes into the invention and is heated or cooled, after being compressed. Then it is released outside of the device.

### LIST OF REFERENCE NUMERALS

A. Compressor
B. Heating coil
C. Cooling coil
D. Shield around unit.
E. Vent
F. Switch—(logic) heat or cool coil
G. Switch—coil (off/on) or door (open/close)
H. Gears
I. other vent
J. fan
K. doors
L. Motors
M. Containment area for heating or cooling
N. Tube
0. Motor pole
P. Stainless steel finish

### DESCRIPTION

Use coils to heat or cool air that is compressed with compressor. To make cooling coil use magnetic bottle to contain lightning shot at containment area (from tesla coil). Shine laser at electrons to make MagneticWave laser. Use to push protons from dirt into other material (this will become protonically charged and when electricity is added to it, it will cool what is close to it.

### ALTERNATIVE EMBODIMENTS

Use different designs that go with the theory of the above. Use only heating coil or only cooling coil.

### SPECS

It should heat or cool a room with a lot less power. I guess it would be about a tenth or a thousandth the power. Doors/gears/motors—as stated. Containment area is where compression occurs. Tube is as stated. Compressor is made up of motor, pole, and fan. In one direction.

### OTHER

This should use a lot less power to heat or cool a room 100 Joules—27 meters squared times 10\hat{ }−2 kilogram/meter squared times 10 meters/(seconds squared)*30 degrees Celsius—is the least amount (theory) to cool or heat a room 2000 watts times 10 minutes (nowadays) is about 1 million joules (average). This invention has a higher energy transfer rate. It should take less than 10 minutes to heat or cool a room.

### CONCLUSIONS

This should help solve energy problems. And stop a lot of household fires.

1. This invention, the heater/cooler compressor, will be a better heater or cooler than just a heating coil and air conditioners. It will be quicker to heat or cool a room with about a tenth less power.
